(19) United States
(12) Patent Application Publication
(10) Pub. No.: US 2008/0048943 A1
(43) Pub. Date: Feb. 28, 2008

(54) Plasma display device

(75) Inventors: Tomoya Matsui, Kawasaki (JP); Isao Furukawa, Tama (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/642,729

(22) Filed: Dec. 21, 2006

(30) Foreign Application Priority Data
Aug. 22, 2006 (JP) 2006-224996

(51) Int. Cl. G09G 3/28

(52) U.S. Cl. 345/67

(57) ABSTRACT

A plasma display device is provided, which includes: a first electrode; a second electrode adjacent to the first electrode; a third electrode adjacent to the second electrode at an opposite side of the first electrode, and performing sustain discharges with the second electrode; and a drive circuit supplying plural first sustain discharge pulses, second sustain discharge pulses, and third sustain discharge pulses for the sustain discharges to the first electrode, the second electrode, and the third electrode respectively, and edges of the first sustain discharge pulses and edges of the second sustain discharge pulses have the edges of which phases are the same with each other and the edges of which the phases are different from each other.

### CROSS-REFERENCE TO RELATED APPLICATIONS

This application is based upon and claims the benefit of priority from the prior Japanese Patent Application No. 2006-224996, filed on Aug. 22, 2006, the entire contents of which are incorporated herein by reference.

### BACKGROUND OF THE INVENTION

1. Field of the Invention

The present invention relates to a plasma display device.

2. Description of the Related Art

A drive method of a plasma display panel is described in the following Patent Document 1, in which at least one of first row electrodes or second row electrodes are divided into plural groups, and pulses with different phases are applied to the respective groups for an AC type plasma display panel in which a discharge cell is constituted by a column electrode, the first row electrode crossing overhead with the column electrode, and the second row electrode disposed in parallel with the first row electrode, and in which pulse widths of the pulses applied between the first row electrodes and the second row electrodes of the respective groups are made to be the same. It becomes possible to uniform light-emission luminance by each electrode pair group by eliminating a difference thereof, by dividing at least one of the first row electrodes or the second row electrodes into plural groups, applying the pulses with different phases to the respective groups, and making the pulse widths of the pulses applied between the first row electrodes and the second row electrodes of the respective groups.

[Patent Document 1] Japanese Patent Application Laid-open No. 2001-142431

### SUMMARY OF THE INVENTION

An object of the present invention is to provide a plasma display device capable of preventing a luminance step which is a so-called streaking and reducing a power consumption.

A plasma display device according to the present invention includes: a first electrode; a second electrode adjacent to the first electrode; a third electrode adjacent to the second electrode at an opposite side of the first electrode, and performing sustain discharges with the second electrode; and a drive circuit supplying plural first sustain discharge pulses, second sustain discharge pulses, and third sustain discharge pulses for the sustain discharges to the first electrode, the second electrode, and the third electrode respectively, and wherein edges of the first sustain discharge pulses and edges of the second sustain discharge pulses have the edges of which phases are the same with each other and the edges of which phases are different from each other.

Besides, a plasma display device according to the present invention, includes: a first electrode; a second electrode adjacent to the first electrode; a third electrode adjacent to the second electrode at an opposite side of the first electrode, and performing sustain discharges with the second electrode; a fourth electrode adjacent to the third electrode at an opposite side of the second electrode; and a drive circuit supplying plural first sustain discharge pulses, second sustain discharges pulses, third sustain discharge pulses, and fourth sustain discharge pulses for the sustain discharge to the first electrode, the second electrode, the third electrode, and the fourth electrode respectively, wherein phases of edges of the first sustain discharge pulses and edges of the second sustain discharge pulses are the same with each other, and wherein phases of edges of the third sustain discharge pulses and edges of the fourth sustain discharge pulses are different from each other.

### BRIEF DESCRIPTION OF THE DRAWINGS

FIG. 1 is a view showing a configuration example of a plasma display device according to a first embodiment of the present invention;

FIG. 2 is an exploded perspective view showing a configuration example of a plasma display panel;

FIG. 3 is a timing chart to explain operation examples of a reset period, an address period, and a sustain discharge period;

FIG. 4 is a view showing voltage waveforms of X electrodes and Y electrodes during the sustain discharge period;

FIG. 5 is a view showing a voltage waveform example of X electrodes and Y electrodes during the sustain discharge period according to the first embodiment;

FIG. 6 is a view showing a disposition example of X electrodes and Y electrodes according to a second embodiment of the present invention;

FIG. 7 is a view showing voltage waveforms of the X electrodes and the Y electrodes during the sustain discharge period in FIG. 6;

FIG. 8 is a view showing a voltage waveform example of the X electrodes and the Y electrodes during the sustain discharge period according to the second embodiment; and

FIG. 9 is a view showing a voltage waveform example of X electrodes and Y electrodes during the sustain discharge period according to a third embodiment of the present invention.

### DETAILED DESCRIPTION OF THE PREFERRED EMBODIMENTS

### First Embodiment

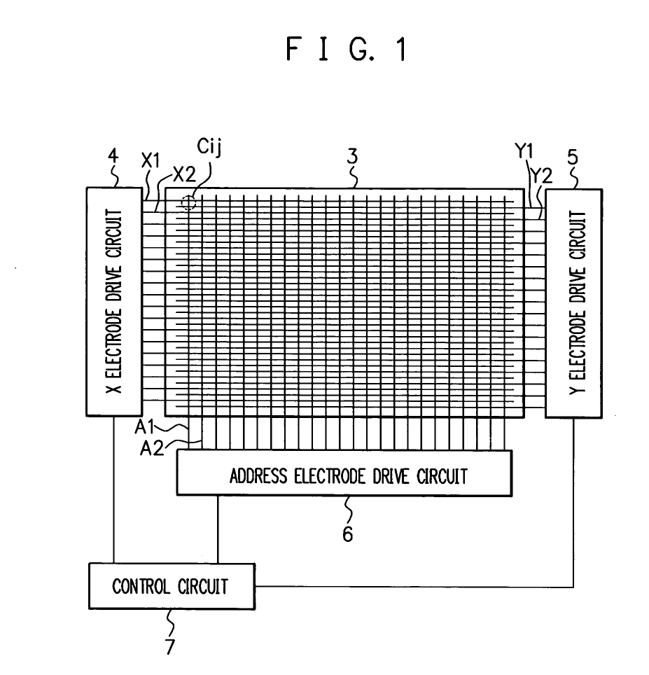

FIG. 1 is a view showing a configuration example of a plasma display device according to a first embodiment of the present invention. A control circuit 7 controls an X electrode drive circuit 4, a Y electrode drive circuit 5, and an address electrode drive circuit 6. The X electrode drive circuit 4 supplies a predetermined voltage to plural X electrodes X1, X2, and so on. Hereinafter, each of the X electrodes X1, X2, and so on, or a generic thereof is referred to as an X electrode X1, and the “i” means a subscript. The Y electrode drive circuit 5 supplies a predetermined voltage to plural Y (scan) electrodes Y1, Y2, and so on. Hereinafter, each of the Y electrodes Y1, Y2, and so on, or a generic thereof is referred to as a Y electrode Y1, and the “i” means a subscript. The address electrode drive circuit 6 supplies a predetermined voltage to plural address electrodes A1, A2, and so on. Hereinafter, each of the address electrodes A1, A2, and so on, or a generic thereof is referred to as an address electrode Aj, and the “j” means a subscript.

In a plasma display panel 3, the Y electrodes Yi and the X electrodes Xi form rows extending in parallel in a horizontal direction, and the address electrodes Aj form columns extending in a vertical direction. The Y electrodes Yi and the X electrodes Xi are disposed alternately in the vertical direction. The Y electrodes Yi and the address electrodes Aj form a two-dimensional matrix of i rows and j columns. A display cell Cij is formed by an intersection of the Y electrode Yi and the address electrode Aj and the X electrode Xi corresponding and adjacent to the intersection. This display cell Cij corresponds to a pixel, and the plasma display panel 3 is able to display a two-dimensional image.

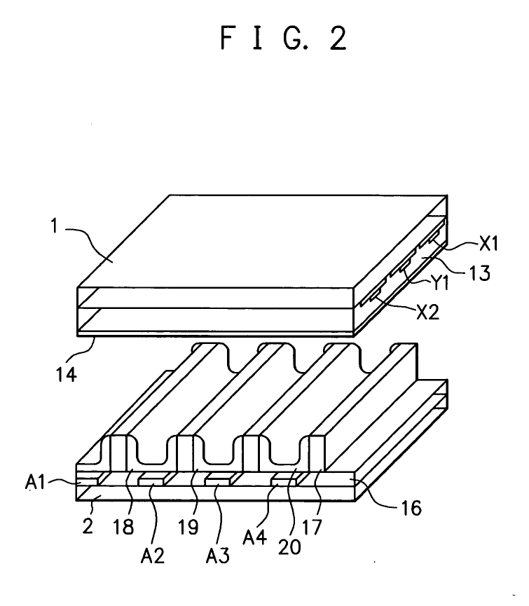

FIG. 2 is an exploded perspective view showing a configuration example of the plasma display panel 3. The X electrodes Xi and the Y electrodes Yi are formed on a front glass substrate 1. A dielectric layer 13 is deposited thereon to provide insulation for a discharge space. An MgO (magnesium oxide) protective layer 14 is deposited further thereon. Whereas, the address electrodes Aj are formed on a rear glass substrate 2 disposed to face the front glass substrate 1. A dielectric layer 16 is deposited thereon. Phosphors 18 to 20 are deposited further thereon. The phosphors 18 to 20 of red, blue, and green are arranged and coated by each color in a stripe state at inner surfaces of barrier ribs 17. The phosphors 18 to 20 are excited by discharges between the X electrodes Xi and the Y electrodes Yi, and each color emits light. Ne+Xe penning gas or the like is sealed in the discharge space between the front glass substrate 1 and the rear glass substrate 2.

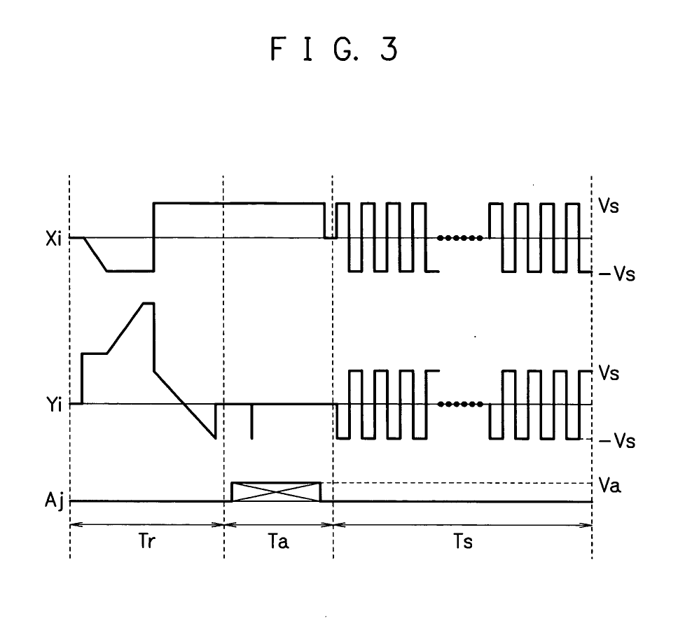

FIG. 3 is a timing chart to explain operation examples of a reset period Tr, an address period Ta, and a sustain discharge period Ts. In the reset period Tr, an initialization of the display cells Cij is performed by applying predetermined voltage to the X electrodes Xi and the Y electrodes Yi.

In the address period Ta, scan pulses are sequentially scanned and applied to the Y electrodes Y1, Y2, and so on, and address pulses are applied to the address electrodes Aj corresponding to the scan pulses, to thereby select display pixels. When the address pulse of the address electrode Aj is generated corresponding to the scan pulse of the Y electrode Yi, the display cell of the Y electrode Yi and the X electrode Xi is selected. When the address pulse of the address electrode Aj is not generated corresponding to the scan pulse of the Y electrode Yi, the display cell of the Y electrode Yi and the X electrode Xi is not selected. When the address pulse is generated corresponding to the scan pulse, an address discharge between the address electrode Aj and the Y electrode Yi occurs to be a pilot frame, and a discharge between the X electrode Xi and the Y electrode Yi occurs, then a negative electric charge is accumulated at the X electrode Xi, and a positive electric charge is accumulated at the Y electrode Yi.

In the sustain discharge period Ts, sustain discharge pulses with opposite phases with each other are applied between the X electrodes Xi and the Y electrodes Yi, the sustain discharge is performed between the X electrode Xi and the Y electrode Yi of the selected display cell to perform a light-emission.

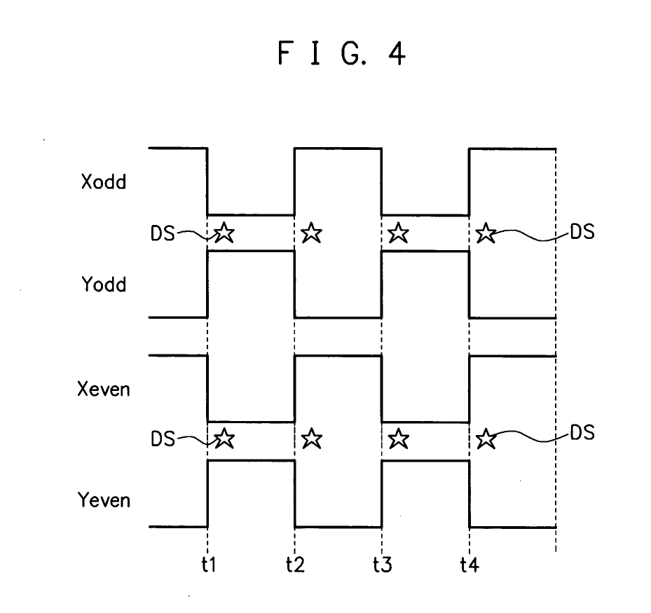

FIG. 4 is a view showing voltage waveforms of the X electrodes and the Y electrodes during the sustain discharge period Ts. An X electrode Xodd shows the voltage waveform of the odd-numbered X electrodes X1, X3, X5, and so on. A Y electrode Yodd shows the voltage waveform of the odd-numbered Y electrodes Y1, Y3, Y5, and so on. An X electrode Xeven shows the voltage waveform of the even-numbered X electrodes X2, X4, X6, and so on. A Y electrode Yeven shows the voltage waveform of the even-numbered Y electrodes Y2, Y4, Y6, and so on.

At the time t1, sustain discharge pulses of the X electrode Xodd and the X electrode Xeven have falling edges, and the sustain discharge pulses of the Y electrode Yodd and the Y electrode Yeven have rising edges. A potential difference of 2×Vs occurs between the adjacent X electrode Xodd and Y electrode Yodd, and a light-emission by a discharge DS occurs. Besides, the potential difference of 2×Vs also occurs between the adjacent X electrode Xeven and Y electrode Yeven, and the light-emission by the discharge DS occurs.

Next, at the time t2, the sustain discharge pulses of the X electrode Xodd and the X electrode Xeven have the rising edges, and the sustain discharge pulses of the Y electrode Yodd and the Y electrode Yeven have the falling edges. The potential difference of 2×Vs occurs between the adjacent X electrode Xodd and Y electrode Yodd, and the light-emission by the discharge DS occurs. Besides, the potential difference of 2×Vs also occurs between the adjacent X electrode Xeven and Y electrode Yeven, and the light-emission by the discharge DS occurs.

Next, at the time t3, the sustain discharge pulses of the X electrode Xodd and the X electrode Xeven have the falling edges, and the sustain discharge pulses of the Y electrode Yodd and the Y electrode Yeven have the rising edges. The potential difference of 2×Vs occurs between the adjacent X electrode Xodd and Y electrode Yodd, and the light-emission by the discharge DS occurs. Besides, the potential difference of 2×Vs also occurs between the adjacent X electrode Xeven and Y electrode Yeven, and the light-emission by the discharge DS occurs.

Next, at the time t4, the sustain discharge pulses of the X electrode Xodd and the X electrode Xeven have the rising edges, and the sustain discharge pulses of the Y electrode Yodd and the Y electrode Yeven have the falling edges. The potential difference of 2×Vs occurs between the adjacent X electrode Xodd and Y electrode Yodd, and the light-emission by the discharge DS occurs. Besides, the potential difference of 2×Vs also occurs between the adjacent X electrode Xeven and Y electrode Yeven, and the light-emission by the discharge DS occurs.

At the times t1, t2, t3, and t4 of the sustain discharge period Ts, the phases of the edges of the sustain discharge pulses of the X electrodes and the Y electrodes are the same with each other. Accordingly, all of the display cells Cij emit lights simultaneously at the time of the sustain discharges DS, and discharge current flowing in the X electrodes and the Y electrodes becomes large. This discharge current depends on a line load. The discharge current changes depending on the line load, and luminance changes to thereby deteriorate a streaking. Namely, for example, the more the number of light-emitting pixels within the same line, the larger the discharge current becomes, the lower a discharge voltage becomes, and the lower the luminance becomes. As a result, a high luminance line and a low luminance line may occur within the same class value, to thereby generate a luminance step. This phenomenon is the streaking.

Besides, the sustain discharge pulses of the Y electrode Yodd and the X electrode Xeven have the potential difference, and therefore, a capacitance between the Y electrode Yodd and the X electrode Xeven appears, and a power consumption increases. Similarly, the sustain discharge pulses of the Y electrode Yeven and the X electrode Xodd have the potential difference, and therefore, a capacitance between the Y electrode Yeven and the X electrode Xodd appears, and the power consumption increases.

As stated above, the sustain discharges DS occur at all of the display cells Cij at the same time, and therefore, the discharge current flows in the X electrodes and the Y electrodes simultaneously to be very large. The discharge current becomes large, then the discharge voltage deteriorates caused by resistance of the electrodes of their own to lower the luminance. Besides, the discharge current depends on the number of light-emitting display cells Cij, and therefore, when a display rate within one line becomes large, the discharge current increases and the luminance is lowered. When the display rate becomes small, the discharge current decreases and the luminance increases. Consequently, the luminance step occurs depending on a display pattern such as a combination of a display with a low display rate and a display with a high display rate within one line, to be a factor to deteriorate the streaking.

In order to improve the streaking, the phases of the sustain discharge pulses of the X electrodes and the Y electrodes are to be displaced to thereby disperse timings of occurrences of the sustain discharges DS to reduce the discharge current. However, if the phases of the sustain discharge pulses are displaced, the phases of the sustain discharge pulses of the X electrode and the Y electrode adjacent at the opposite side are displaced, and thereby, the capacitance between the adjacent electrodes appears to increase the power consumption. For example, the capacitance appears between the Y electrode Yodd and the X electrode Xeven in which the discharge does not occur, and further, the capacitance appears between the Y electrode Yeven and the X electrode Xodd to thereby increase the power consumption.

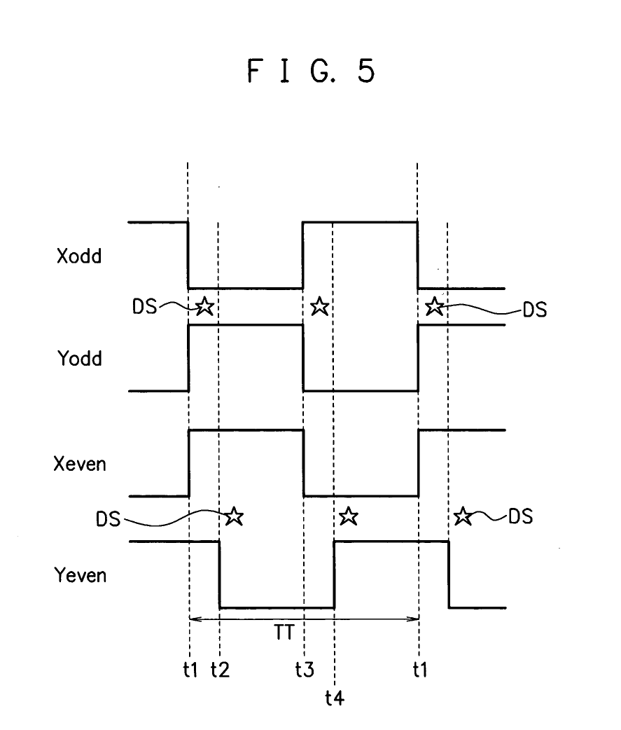

FIG. 5 is a view showing a voltage waveform example of the X electrodes and the Y electrodes during the sustain discharge period Ts according to the present embodiment. A first electrode Yodd shows a voltage waveform of the odd-numbered Y electrodes Y1, Y3, Y5, and so on. A second electrode Xeven shows the voltage waveform of the even-numbered X electrodes X2, X4, X6, and so on. A third electrode Yeven shows the voltage waveform of the even-numbered Y electrodes Y2, Y4, Y6, and so on. A fourth electrode Xodd shows the voltage waveform of the odd-numbered X electrodes X1, X3, X5, and so on. The Y electrodes Yodd and Yeven are the electrodes to apply the scan pulses to select whether a sustain discharge is to be performed or not in the address period Ta in FIG. 3.

The electrode Xeven (for example X2) is adjacent to the electrode Yodd (for example Y1). The electrode Yeven (for example Y2) is adjacent to the electrode Xeven (for example X2) at an opposite side of the electrode Yodd (for example Y1), and it is the electrode to perform the sustain discharge with the electrode Xeven (for example X2). The electrode Xodd (for example X3) is adjacent to the electrode Yeven (for example Y2) at the opposite side of the electrode Xeven (for example X2), and it is the electrode to perform the sustain discharge with the electrode Yodd (for example Y3).

At the time t1, a sustain discharge pulse of the X electrode Xodd has a falling edge, and the sustain discharge pulses of the Y electrode Yodd and the X electrode Xeven have rising edges. A potential difference of 2×Vs occurs between the adjacent X electrode Xodd and Y electrode Yodd, and a light-emission by a discharge DS occurs. For example, the discharge DS occurs between the X electrode X1 and the Y electrode Y1.

Next, at the time t2, the sustain discharge pulse of the Y electrode Yeven has the falling edge. The potential difference of 2×Vs occurs between the adjacent X electrode Xeven and Y electrode Yeven, and the light-emission by the discharge DS occurs. For example, the discharge DS occurs between the X electrode X2 and the Y electrode Y2.

Next, at the time t3, the sustain discharge pulse of the X electrode Xodd has the rising edge, and the sustain discharge pulses of the Y electrode Yodd and the X electrode Xeven have the falling edges. The potential difference of 2×Vs occurs between the adjacent X electrode Xodd and Y electrode Yodd, and the light-emission by the discharge DS occurs.

Next, at the time t4, the sustain discharge pulse of the Y electrode Yeven has the rising edge. The potential difference of 2×Vs occurs between the adjacent X electrode Xeven and Y electrode Yeven, and the light-emission by the discharge DS occurs.

As stated above, one cycle TT includes the times t1 to t4, and it is from the time t1 to the next time t1. In the sustain discharge period Ts, this cycle TT is executed repeatedly.

Phases of the edges of the sustain discharge pulses of the Y electrode Yodd and the edges of the sustain discharge pulses of the X electrode Xeven are the same with each other. Accordingly, a capacitance between the Y electrode Yodd and the X electrode Xeven does not appear, and the power consumption can be reduced.

On the contrary, the phases of the edges of the sustain discharge pulses of the Y electrode Yeven and the edges of the sustain discharge pulses of the X electrode Xodd are different from each other. Accordingly, all of the above-stated four discharges DS occur at the different times t1, t2, t3, and t4, and therefore, a discharge current becomes small and a streaking can be prevented. Namely, a luminance step between lines can be prevented.

According to the present embodiment, it is possible to prevent the luminance step between the lines, and to reduce the power consumption.

### Second Embodiment

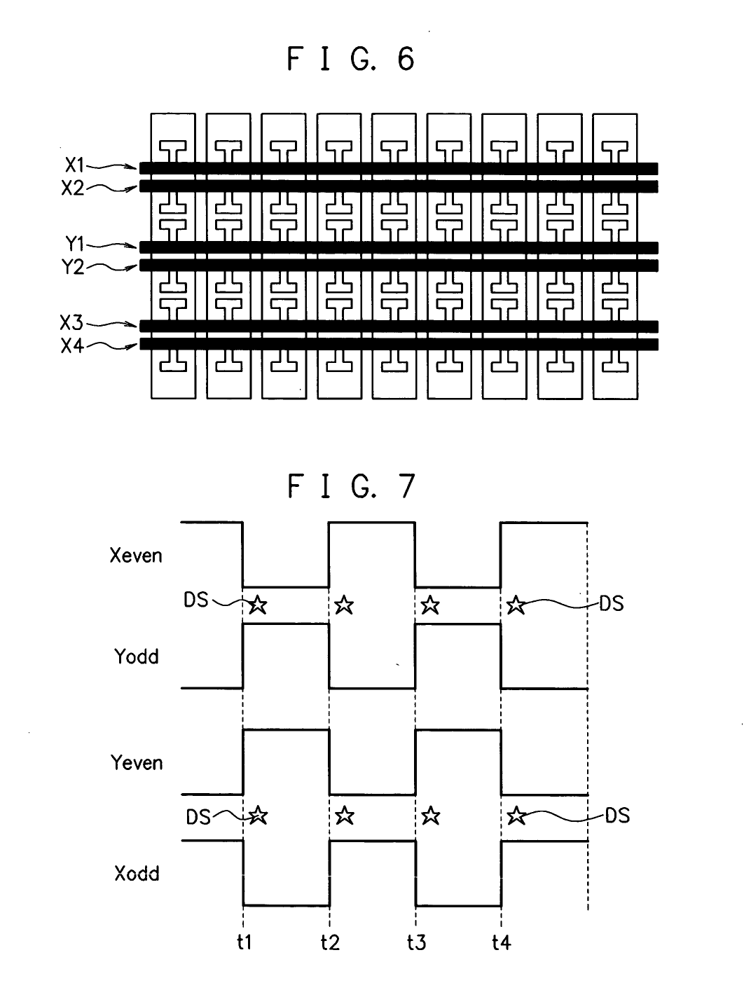

FIG. 6 is a view showing a disposition example of X electrodes and Y electrodes according to a second embodiment of the present invention. In the first embodiment (FIG. 1), the example is shown in which the X electrodes and the Y electrodes are disposed alternately in the vertical direction. In the second embodiment, the X electrodes and the Y electrodes are disposed two by two alternately in the vertical direction. Concretely speaking, an X electrode X1, an X electrode X2, a Y electrode Y1, a Y electrode Y2, an X electrode X3, an X electrode X4, and so on are disposed sequentially from a top. A voltage is supplied to the X electrodes from an X electrode drive circuit 4. The voltage is supplied to the Y electrodes from a Y electrode drive circuit 5.

FIG. 7 is a view showing voltage waveforms of the X electrodes and the Y electrodes during a sustain discharge period TS. An X electrode Xeven shows the voltage waveform of the even-numbered X electrodes X2, X4, X6, and so on. A Y electrode Yodd shows the voltage waveform of the odd-numbered Y electrodes Y1, Y3, Y5, and so on. A Y electrode Yeven shows the voltage waveform of the even-numbered Y electrodes Y2, Y4, Y6, and so on. An X electrode Xodd shows the voltage waveform of the odd-numbered X electrodes X1, X3, X5, and so on.

At the time t1, sustain discharge pulses of the X electrode Xeven and the X electrode Xodd have falling edges, and sustain discharge pulses of the Y electrode Yodd and the Y electrode Yeven have rising edges. A potential difference of 2×Vs occurs between the adjacent X electrode Xeven and Y electrode Yodd, and a light-emission by a discharge DS occurs. Besides, the potential difference of 2×Vs also occurs between the adjacent Y electrode Yeven and X electrode Xodd, and the light-emission by the discharge DS occurs.

Next, at the time t2, the sustain discharge pulses of the X electrode Xeven and the X electrode Xodd have the rising edges, and the sustain discharge pulses of the Y electrode Yodd and the Y electrode Yeven have the falling edges. The potential difference of 2×Vs occurs between the adjacent X electrode Xeven and Y electrode Yodd, and the light-emission by the discharge DS occurs. Besides, the potential difference of 2×Vs also occurs between the adjacent Y electrode Yeven and X electrode Xodd, and the light-emission by the discharge DS occurs.

Next, at the time t3, the sustain discharge pulses of the X electrode Xeven and the X electrode Xodd have the falling edges, and the sustain discharge pulses of the Y electrode Yodd and the Y electrode Yeven have the rising edges. The potential difference of 2×Vs occurs between the adjacent X electrode Xeven and Y electrode Yodd, and the light-emission by the discharge DS occurs. Besides, the potential difference of 2×Vs also occurs between the adjacent Y electrode Yeven and X electrode Xodd, and the light-emission by the discharge DS occurs.

Next, at the time t4, the sustain discharge pulses of the X electrode Xeven and the X electrode Xodd have the rising edges, and the sustain discharge pulses of the Y electrode Yodd and the Y electrode Yeven have the falling edges. The potential difference of 2×Vs occurs between the adjacent X electrode Xeven and Y electrode Yodd, and the light-emission by the discharge DS occurs. Besides, the potential difference of 2×Vs also occurs between the adjacent Y electrode Yeven and X electrode Xodd, and the light-emission by the discharge DS occurs.

The potentials of the sustain discharge pulses of the adjacent Y electrode Yodd and Y electrode Yeven are the same, and therefore, a capacitance between the Y electrode Yodd and the Y electrode Yeven does not appear, and the power consumption can be reduced. Similarly, the potentials of the sustain discharge pulses of the adjacent X electrode Xodd and X electrode Xeven are the same, and therefore, a capacitance between the X electrode Xodd and the X electrode Xeven does not appear, and the power consumption can be reduced.

However, all of display cells Cij perform discharges DS at the same time, and a large discharge current flows in the X electrodes and the Y electrodes, to thereby deteriorate a streaking.

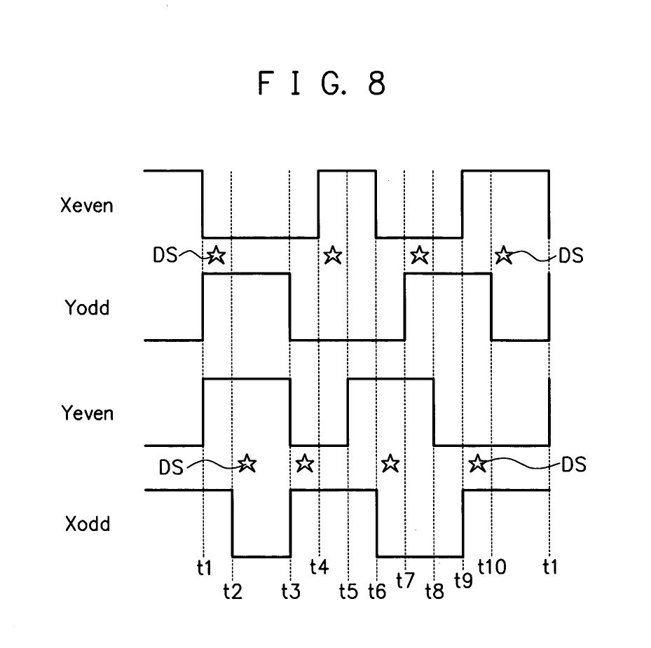

FIG. 8 is a view showing a voltage waveform example of the X electrodes and the Y electrodes during the sustain discharge period TS according to the present embodiment. A first electrode Yodd shows a voltage waveform of the odd-numbered Y electrodes Y1, Y3, Y5, and so on. A second electrode Yeven shows the voltage waveform of the even-numbered Y electrodes Y2, Y4, Y6, and so on. A third electrode Xodd shows the voltage waveform of the odd-numbered X electrodes X1, X3, X5, and so on. A fourth electrode Xeven shows the voltage waveform of the even-numbered X electrodes X2, X4, X6, and so on. The Y electrodes Yodd and Yeven are the electrodes to apply scan pulses to select whether a sustain discharge is to be performed or not in the address period Ta in FIG. 3.

The electrode Yeven (for example Y2) is adjacent to the electrode Yodd (for example Y1). The electrode Xodd (for example X3) is adjacent to the electrode Yeven (for example Y2) at an opposite side of the electrode Yodd (for example Y1), and it is the electrode to perform the sustain discharge with the electrode Yeven (for example Y2). The electrode Xeven (for example X4) is adjacent to the electrode Xodd (for example X3) at the opposite side of the electrode Yeven (for example Y2), and it is the electrode to perform the sustain discharge with the electrode Yodd (for example Y3).

At the time t1, a sustain discharge pulse of the X electrode Xeven has a falling edge, and the sustain discharge pulses of the Y electrode Yodd and the Y electrode Yeven have rising edges. A potential difference of 2×Vs occurs between the adjacent X electrode Xeven and Y electrode Yodd, and a light-emission by a discharge DS occurs. For example, the discharge DS occurs between the X electrode X2 and the Y electrode Y1.

Next, at the time t2, the sustain discharge pulse of the X electrode Xodd has the falling edge. The potential difference of 2×Vs occurs between the adjacent Y electrode Yeven and X electrode Xodd, and the light-emission by the discharge DS occurs. For example, the discharge DS occurs between the Y electrode Y2 and the X electrode X3.

Next, at the time t3, the sustain discharge pulses of the Y electrodes Yodd and Yeven have the falling edges, and the sustain discharge pulse of the X electrode Xodd has the rising edge. The potential difference of 2×Vs occurs between the adjacent Y electrode Yeven and X electrode Xodd, and the light-emission by the discharge DS occurs.

Next, at the time t4, the sustain discharge pulse of the X electrode Xeven has the rising edge. The potential difference of 2×Vs occurs between the adjacent X electrode Xeven and Y electrode Yodd, and the light-emission by the discharge DS occurs.

Next, at the time t5, the sustain discharge pulse of the Y electrode Yeven has the rising edge.

Next, at the time t6, the sustain discharge pulses of the X electrodes Xeven and Xodd have the falling edges. The potential difference of 2×Vs occurs between the adjacent Y electrode Yeven and X electrode Xodd, and the light-emission by the discharge DS occurs.

Next, at the time t7, the sustain discharge pulse of the Y electrode Yodd has the rising edge. The potential difference of 2×Vs occurs between the adjacent X electrode Xeven and Y electrode Yodd, and the light-emission by the discharge DS occurs.

Next, at the time t8, the sustain discharge pulse of the Y electrode Yeven has the falling edge.

Next, at the time t9, the sustain discharge pulses of the X electrodes Xeven and Xodd have the rising edges. The potential difference of 2×Vs occurs between the adjacent Y electrode Yeven and X electrode Xodd, and the light-emission by the discharge DS occurs.

Next, at the time t10, the sustain discharge pulse of the Y electrode Yodd has the falling edge. The potential difference of 2×Vs occurs between the adjacent X electrode Xeven and Y electrode Yodd, and the light-emission by the discharge DS occurs.

As stated above, one cycle includes the times t1 to t10, and it is from the time t1 to the next time t1. In the sustain discharge period Ts, this cycle is performed repeatedly.

At the times t1 and t3, phases of the edges of the sustain discharge pulses of the Y electrodes Yodd and Yeven are the same with each other. Accordingly, a capacitance between the Y electrodes Yodd and Yeven does not appear, and the power consumption can be reduced.

Besides, at the times t6 and t9, the phases of the edges of the sustain discharge pulses of the X electrodes Xodd and Xeven are the same with each other. Accordingly, the capacitance between the X electrodes Xodd and Xeven does not appear, and the power consumption can be reduced.

On the contrary, at the times t1, t2, t3, and t4, the phases of the edges of the sustain discharge pulses of the X electrodes Xodd and Xeven are different from each other. Besides, at the times t5, t7, t8, and t10, the phases of the edges of the sustain discharge pulses of the Y electrodes Yodd and Yeven are different from each other. Accordingly, all of the above-stated eight discharges DS occur at the different times t1, t2, t3, t4, t6, t7, t9, and t10, and therefore, a discharge current becomes small and a streaking can be prevented. Namely, a luminance step between lines can be prevented.

The edges of the sustain discharge pulses of the Y electrode Yodd and the edges of the sustain discharge pulses of the Y electrode Yeven have the edges of which phases are the same with each other and the edges of which phases are different from each other. Concretely speaking, the number of edges of which phases are the same with each other and the number of edges of which phases are different from each other are the same within one cycle in the edges of the sustain discharge pulses of the Y electrode Yodd and the edges of the sustain discharge pulses of the Y electrode Yeven.

Similarly, the edges of the sustain discharge pulses of the X electrode Xodd and the edges of the sustain discharge pulses of the X electrode Xeven have the edges of which phases are the same with each other and the edges of which phases are different from each other. Concretely speaking, the number of edges of which phases are the same with each other and the number of edges of which phases are different from each other are the same within one cycle in the edges of the sustain discharge pulses of the X electrode Xodd and the edges of the sustain discharge pulses of the X electrode Xeven.

According to the present embodiment, it is possible to prevent the luminance step between the lines, and to reduce the power consumption.

### Third Embodiment

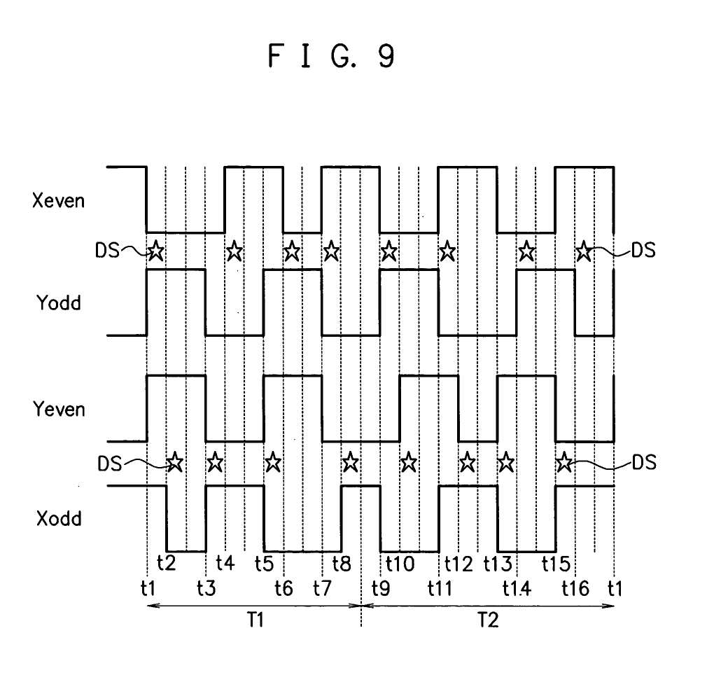

FIG. 9 is a view showing a voltage waveform example of X electrodes and Y electrodes during a sustain discharge period Ts according to a third embodiment of the present invention. A disposition of the X electrodes and the Y electrodes is as shown in FIG. 6. Different points of the present embodiment from the second embodiment are described.

At the time t1, the sustain discharge pulse of the X electrode Xeven has the falling edge, and the sustain discharge pulses of the Y electrode Yodd and the Y electrode Yeven have the rising edges. The potential difference of 2×Vs occurs between the adjacent X electrode Xeven and Y electrode Yodd, and the light-emission by the discharge DS occurs. For example, the discharge DS occurs between the X electrode X2 and the Y electrode Y1.

At the time t2, the sustain discharge pulse of the X electrode Xodd has the falling edge. The potential difference of 2×Vs occurs between the adjacent Y electrode Yeven and X electrode Xodd, and the light-emission by the discharge DS occurs. For example, the discharge DS occurs between the Y electrode Y2 and the X electrode X3.

At the time t3, the sustain discharge pulses of the Y electrodes Yodd and Yeven have the falling edges, and the sustain discharge pulse of the X electrode Xodd has the rising edge. The potential difference of 2×Vs occurs between the adjacent Y electrode Yeven and X electrode Xodd, and the light-emission by the discharge DS occurs.

At the time t4, the sustain discharge pulse of the X electrode Xeven has the rising edge. The potential difference of 2×Vs occurs between the adjacent X electrode Xeven and Y electrode Yodd, and the light-emission by the discharge DS occurs.

At the time t5, the sustain discharge pulses of the Y electrodes Yodd and Yeven have the rising edges, and the sustain discharge pulse of the X electrode Xodd has the falling edge. The potential difference of 2×Vs occurs between the adjacent Y electrode Yeven and X electrode Xodd, and the light-emission by the discharge DS occurs.

At the time t6, the sustain discharge pulse of the X electrode Xeven has the falling edge. The potential difference of 2×Vs occurs between the adjacent X electrode Xeven and Y electrode Yodd, and the light-emission by the discharge DS occurs.

At the time t7, the sustain discharge pulse of the X electrode Xeven has the rising edge, and the sustain discharge pulses of the Y electrodes Yodd and Yeven have the falling edges. The potential difference of 2×Vs occurs between the adjacent X electrode Xeven and Y electrode Yodd, and the light-emission by the discharge DS occurs.

At the time t8, the sustain discharge pulse of the X electrode Xodd has the rising edge. The potential difference of 2×Vs occurs between the adjacent Y electrode Yeven and X electrode Xodd, and the light-emission by the discharge DS occurs.

At the time t9, the sustain discharge pulses of the X electrodes Xeven and Xodd have the falling edges, and the sustain discharge pulse of the Y electrode Yodd has the rising edge. The potential difference of 2×Vs occurs between the adjacent X electrode Xeven and Y electrode Yodd, and the light-emission by the discharge DS occurs.

At the time t10, the sustain discharge pulse of the Y electrode Yeven has the rising edge. The potential difference of 2×Vs occurs between the adjacent Y electrode Yeven and X electrode Xodd, and the light-emission by the discharge DS occurs.

At the time t11, the sustain discharge pulses of the X electrodes Xeven and Xodd have the rising edges, and the sustain discharge pulse of the Y electrode Yodd has the falling edge. The potential difference of 2×Vs occurs between the adjacent X electrode Xeven and Y electrode Yodd, and the light-emission by the discharge DS occurs.

At the time t12, the sustain discharge pulse of the Y electrode Yeven has the falling edge. The potential difference of 2×Vs occurs between the adjacent Y electrode Yeven and X electrode Xodd, and the light-emission by the discharge DS occurs.

At the time t13, the sustain discharge pulses of the X electrodes Xeven and Xodd have the falling edges, and the sustain discharge pulse of the Y electrode Yeven has the rising edge. The potential difference of 2×Vs occurs between the adjacent Y electrode Yeven and X electrode Xodd, and the light-emission by the discharge DS occurs.

At the time t14, the sustain discharge pulse of the Y electrode Yodd has the rising edge. The potential difference of 2×Vs occurs between the adjacent X electrode Xeven and Y electrode Yodd, and the light-emission by the discharge DS occurs.

At the time t15, the sustain discharge pulses of the X electrodes Xeven and Xodd have the rising edges, and the sustain discharge pulse of the Y electrode Yeven has the falling edge. The potential difference of 2×Vs occurs between the adjacent Y electrode Yeven and X electrode Xodd, and the light-emission by the discharge DS occurs.

At the time t16, the sustain discharge pulse of the Y electrode Yodd has the falling edge. The potential difference of 2×Vs occurs between the adjacent X electrode Xeven and Y electrode Yodd, and the light-emission by the discharge DS occurs.

As stated above, one cycle includes the times t1 to t16, and it is from the time t1 to the next time t1. In the sustain discharge period Ts, this cycle is performed repeatedly.

At the times t1, t3, t5 and t7, the phases of the edges of the sustain discharge pulses of the Y electrodes Yodd and Yeven are the same with each other. Accordingly, the capacitance between the Y electrodes Yodd and Yeven does not appear, and the power consumption can be reduced.

Besides, at the times t9, t11, t13 and t15, the phases of the edges of the sustain discharge pulses of the X electrodes Xodd and Xeven are the same with each other. Accordingly, the capacitance between the X electrodes Xodd and Xeven does not appear, and the power consumption can be reduced.

On the contrary, at the times t1, t2, t3, t4, t5, t6, t7 and t8, the phases of the edges of the sustain discharge pulses of the X electrodes Xodd and Xeven are different from each other. Besides, at the times t9, t10, t11, t12, t13, t14, t15 and t16, the phases of the edges of the sustain discharge pulses of the Y electrodes Yodd and Yeven are different from each other. Accordingly, all of the above-stated 16 discharges DS occur at the different times, and therefore, the discharge current becomes small and the streaking can be prevented. Namely, the luminance step between lines can be prevented.

The edges of the sustain discharge pulses of the Y electrode Yodd and the edges of the sustain discharge pulses of the Y electrode Yeven have the edges of which phases are the same with each other and the edges of which phases are different from each other. Concretely speaking, the number of edges of which phases are the same with each other and the number of edges of which phases are different from each other are the same within one cycle, in the edges of the sustain discharge pulses of the Y electrode Yodd and the edges of the sustain discharge pulses of the Y electrode Yeven.

Similarly, the edges of the sustain discharge pulses of the X electrode Xodd and the edges of the sustain discharge pulses of the X electrode Xeven have the edges of which phases are the same with each other and the edges of which phases are different from each other. Concretely speaking, the number of edges of which phases are the same with each other and the number of edges of which phases are different from each other are the same within one cycle, in the edges of the sustain discharge pulses of the X electrode Xodd and the edges of the sustain discharge pulses of the X electrode Xeven.

According to the present embodiment, it is possible to prevent the luminance step between the lines, and to reduce the power consumption.

A first cycle pattern T1 includes the times from t1 to t8. In the first cycle pattern T1, the phases of the edges of the sustain discharge pulses of the Y electrode Yodd and the edges of the sustain discharge pulses of the Y electrode Yeven are the same with each other, and the phases of the edges of the sustain discharge pulses of the X electrode Xodd and the edges of the sustain discharge pulses of the X electrode Xeven are different from each other. In the sustain discharge period Ts, only the first cycle pattern T1 may be executed repeatedly without using a second cycle pattern T2. Also in that case, it is possible to prevent the luminance step between the lines, and to reduce the power consumption.

Besides, the second cycle pattern T2 includes the times from t9 to t16. In the second cycle pattern T2, the phases of the edges of the sustain discharge pulses of the X electrode Xodd and the edges of the sustain discharge pulses of the X electrode Xeven are the same with each other, and the phases of the edges of the sustain discharge pulses of the Y electrode Yodd and the edges of the sustain discharge pulses of the Y electrode Yeven are different from each other. In the sustain discharge period Ts, only the second cycle pattern T2 may be executed repeatedly without using the first cycle pattern T1. Also in that case, it is possible to prevent the luminance step between the lines, and to reduce the power consumption.

Besides, in the sustain discharge period Ts, the first cycle pattern T1 and the second cycle pattern T2 may be executed in an arbitrary combination. Also in that case, it is possible to prevent the luminance step between the lines, and to reduce the power consumption.

The sustain discharge pulses of the first cycle pattern Ti and the subsequent second cycle pattern T2 are supplied to the X electrodes and the Y electrodes. During the period of the first cycle pattern T1 and the second cycle pattern T2, the edges of the sustain discharge pulses of the Y electrode Yodd and the edges of the sustain discharge pulses of the Y electrode Yeven have the edges of which the phases are the same with each other and the edges of which phases are different from each other. Concretely speaking, during the period of the first cycle pattern Ti and the second cycle pattern T2, the number of edges of which phases are the same with each other and the number of edges of which phases are different from each other are the same, in the edges of the sustain discharge pulses of the Y electrode Yodd and the edges of the sustain discharge pulses of the Y electrode Yeven.

Similarly, during the period of the first cycle pattern T1 and the second cycle pattern T2, the edges of the sustain discharge pulses of the X electrode Xodd and the edges of the sustain discharge pulses of the X electrode Xeven have the edges of which phases are the same with each other and the edges of which phases are different from each other. Concretely speaking, during the period of the first cycle pattern T1 and the second cycle pattern T2, the number of edges of which phases are the same with each other and the number of edges of which phases are different from each other are the same, in the edges of the sustain discharge pulses of the X electrode Xodd and the edges of the sustain discharge pulses of the X electrode Xeven.

As stated above, according to the first to third embodiments, it is possible to make half of the phases of the edges of the sustain discharge pulses the same, and make the rest half of the phases different. If timings of the sustain discharges DS are simply displaced, all of the phases of the edges of the sustain discharge pulses are displaced to thereby enlarge the power consumption. Besides, if all of the phases of the edges of the sustain discharge pulses are simply made the same, the timings of the sustain discharges DS become the same, to thereby generate the luminance step between the lines.

When all of the phases of the edges of the sustain discharge pulses are displaced, the power consumption is doubled compared to the case when all of the phases of the edges of the sustain discharge pulses are the same. On the contrary, when the half of the phases of the edges of the sustain discharge pulses are the same and the rest half of the phases are different as in the first to the third embodiments, the power consumption can be suppressed to be 1.5 times compared to the case when all of the phases of the edges of the sustain discharge pulses are the same, and further, the luminance step between the lines can be prevented.

It is possible to reduce a deterioration of a discharge voltage by dispersing the light-emitting timings of the sustain discharges DS and eliminating the discharge current flowing at one time, and to improve a streaking by eliminating the luminance step. On the other hand, an adjacent capacitance of the X electrodes and/or the Y electrodes appears to increase the power consumption by displacing the phases of the rising edges and/or the falling edges of the sustain discharge pulses. However, the half of the phases of the rising edges and/or the falling edges are matched, and thereby, it becomes possible to suppress the increase of the power consumption and to disperse the light-emitting timings of the sustain discharges DS. It is possible to improve the streaking by dispersing the timings of the sustain discharges DS, and to suppress the increase of the power consumption by displacing the phases of the edges of the sustain discharge pulses.

An AC type plasma display device of the present embodiment can be used for a flat television, and a display for shop window.

It is possible to prevent the luminance step by making the phases of the edges of the sustain discharge pulses of the adjacent electrodes different. Besides, it is possible to reduce the power consumption by making the phases of the edges of the sustain discharge pulses of the adjacent electrodes the same. Accordingly, it becomes possible to prevent the luminance step, and to reduce the power consumption.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device, comprising:
a first electrode;
a second electrode adjacent to said first electrode;
a third electrode adjacent to said second electrode at an opposite side of said first electrode, and performing sustain discharges with said second electrode; and
a drive circuit supplying plural first sustain discharge pulses, second sustain discharge pulses, and third sustain discharge pulses for the sustain discharges to said first electrode, said second electrode, and said third electrode respectively,
wherein edges of the first sustain discharge pulses and edges of the second sustain discharge pulses have the edges of which phases are the same with each other and the edges of which phases are different from each other.

2. The plasma display device according to claim 1,
wherein the number of edges of which phases are the same with each other and the number of edges of which phases are different from each other are the same within one cycle in the edges of the first sustain discharge pulses and the edges of the second sustain discharge pulses.

3. The plasma display device according to claim 1,
wherein said drive circuit supplies a first cycle pattern voltage and a subsequent second cycle pattern voltage to said first electrode, said second electrode, and said third electrode, and
wherein the edges of the first sustain discharge pulses and the edges of the second sustain discharge pulses have the edges of which phases are the same with each other and the edges of which phases are different from each other during a period of the first cycle pattern voltage and the second cycle pattern voltage.

4. The plasma display device according to claim 3,
wherein the number of edges of which phases are the same with each other and the number of edges of which phases are different from each other are the same in the edges of the first sustain discharge pulses and the edges of the second sustain discharge pulses during the period of the first cycle pattern voltage and the second cycle pattern voltage.

5. The plasma display device according to claim 1,
wherein said first electrode and said second electrode are electrodes applying scan pulses to select whether the sustain discharge is to be performed or not.

6. The plasma display device according to claim 2,
wherein said first electrode and said second electrode are electrodes applying scan pulses to select whether the sustain discharge is to be performed or not.

7. The plasma display device according to claim 3,
wherein said first electrode and said second electrode are electrodes applying scan pulses to select whether the sustain discharge is to be performed or not.

8. The plasma display device according to claim 4,
wherein said first electrode and said second electrode are electrodes applying scan pulses to select whether the sustain discharge is to be performed or not.

9. A plasma display device, comprising:
a first electrode;
a second electrode adjacent to said first electrode;
a third electrode adjacent to said second electrode at an opposite side of said first electrode, and performing sustain discharges with said second electrode;
a fourth electrode adjacent to said third electrode at an opposite side of said second electrode; and
a drive circuit supplying plural first sustain discharge pulses, second sustain discharge pulses, third sustain discharge pulses, and fourth sustain discharge pulses for the sustain discharges to said first electrode, said second electrode, said third electrode, and said fourth electrode respectively,
wherein phases of edges of the first sustain discharge pulses and edges of the second sustain discharge pulses are the same with each other, and
wherein phases of edges of the third sustain discharge pulses and edges of the fourth sustain discharge pulses are different from each other.

10. The plasma display device according to claim 9,
wherein said first electrode and said third electrode are electrodes applying scan pulses to select whether the sustain discharge is to be performed or not.

11. The plasma display device according to claim 9,
wherein said first electrode and said second electrode are electrodes applying scan pulses to select whether the sustain discharge is to be performed or not.
